(19) United States
(12) Patent Application Publication
(10) Pub. No.: US 2003/0141329 A1
(43) Pub. Date: Jul. 31, 2003

(54) Removable belt clip system

(76) Inventor: Daniel Huang, Shenzhen (CN)

Correspondence Address: Michael S. Neustel, Suite No. 4, 2534 South University Drive, Fargo, ND, 58103, US

(21) Appl. No.: 10/059,532

(22) Filed: Jan. 30, 2002

(51) Int. Cl. B65D 25/52; A01K 97/04; A01K 97/06; A45F 5/00

(52) U.S. Cl. 224/197; 224/269; 224/271; 224/930

(57) ABSTRACT

A removable belt clip system for providing easy removal and installation of a post member from a carrying case. The removable belt clip system includes a carrying case, a retaining pocket attached to an exterior surface of the case, a receiver opening within the retaining pocket, a resilient member attached at one end of the receiver opening extending a finite distance toward the opposing end of the receiver opening, and a post member having a flat base removably positioned within the receiver opening. The user inserts a second portion of the flat base into the receiver opening then pushes the post member so that the shaft engages and compresses the resilient member. The user then pushes the first portion of the flat base into the receiver opening and then releases the post member whereby the resilient member forces the flat base away from the resilient member thereby causing the first portion to be catchably received within the retaining pocket.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to belt clip devices and more specifically it relates to a removable belt clip system for providing easy removal and installation of a post member from a carrying case.

2. Description of the Prior Art

Carrying cases and belt clip structures have been in use for years. Carrying cases are formed for receiving, storing and protecting various types of devices including but not limited to cellular phones, personal data assistants (PDAs), electronic devices and various other items. A carrying case including an interior portion for receiving the device, a cover for selecting enclosing the device within, and a post having a flanged portion for removably attaching to a belt clip structure. The post typically extends transversely from a rear surface of the carrying case. The belt clip structure typically has a release button that allows for the release of the post from within a receiving slot within thereof.

The main problem with conventional carrying cases and belt clip structures is that the post is permanently secured within the carrying case and cannot be removed from thereof when not attached to the belt clip structure. Another problem with conventional carrying cases and belt clip structures is that the post interferes with the usage of the device within the carrying case.

While these devices may be suitable for the particular purpose to which they address, they are not as suitable for providing easy removal and installation of a post member from a carrying case. Conventional carrying cases and belt clip structures do not allow for the post to be easily removed thereby interfering with the usage of the carrying case when not attached to the belt clip.

In these respects, the removable belt clip system according to the present invention substantially departs from the conventional concepts and designs of the prior art, and in so doing provides an apparatus primarily developed for the purpose of providing easy removal and installation of a post member from a carrying case.

### SUMMARY OF THE INVENTION

In view of the foregoing disadvantages inherent in the known types of removably belt clip structures now present in the prior art, the present invention provides a new removable belt clip system construction wherein the same can be utilized for providing easy removal and installation of a post member from a carrying case.

The general purpose of the present invention, which will be described subsequently in greater detail, is to provide a new removable belt clip system that has many of the advantages of the removably belt clip structures mentioned heretofore and many novel features that result in a new removable belt clip system which is not anticipated, rendered obvious, suggested, or even implied by any of the prior art removably belt clip structures, either alone or in any combination thereof.

To attain this, the present invention generally comprises a carrying case, a retaining pocket attached to an exterior surface of the case, a receiver opening within the retaining pocket, a resilient member attached at one end of the receiver opening extending a finite distance toward the opposing end of the receiver opening, and a post member having a flat base removably positioned within the receiver opening. The user inserts a second portion of the flat base into the receiver opening then pushes the post member so that the shaft engages and compresses the resilient member. The user then pushes the first portion of the flat base into the receiver opening and then releases the post member whereby the resilient member forces the flat base away from the resilient member thereby causing the first portion to be catchably received within the retaining pocket.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a removable belt clip system that will overcome the shortcomings of the prior art devices.

A second object is to provide a removable belt clip system for providing easy removal and installation of a post member from a carrying case.

Another object is to provide a removable belt clip system that eliminates interference with the usage of a device within the carrying case by a post.

An additional object is to provide a removable belt clip system that may be utilized upon various types of carrying cases.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention with respect to a belt clip structure.

FIG. 2 is an upper perspective view of the present invention with a belt clip structure attached thereto.

FIG. 3 is an upper perspective view of the present invention.

FIG. 4 is an upper perspective view of the present invention with the post member manipulated forwardly against the resilient member.

FIG. 5 is an upper perspective view of the present invention with the post member partially removed from the retaining pocket.

FIG. 6 is a cross sectional view taken along line 6-6 of FIG. 3.

FIG. 7 is a cross sectional view taken along line 7-7 of FIG. 4.

FIG. 8 is a cross sectional view taken along line 8-8 of FIG. 5.

FIG. 9 is a cross sectional view of the post member being removed from the retaining pocket.

FIG. 10 is an upper perspective view of the post member.

FIG. 11 is a side view of the post member.

### DESCRIPTION OF THE PREFERRED EMBODIMENT

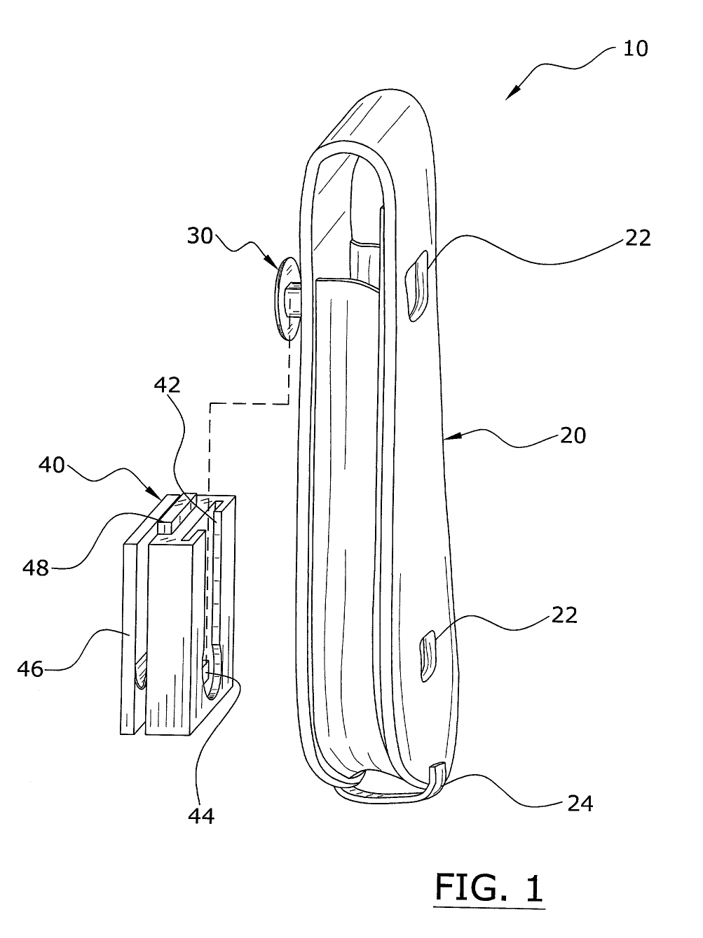

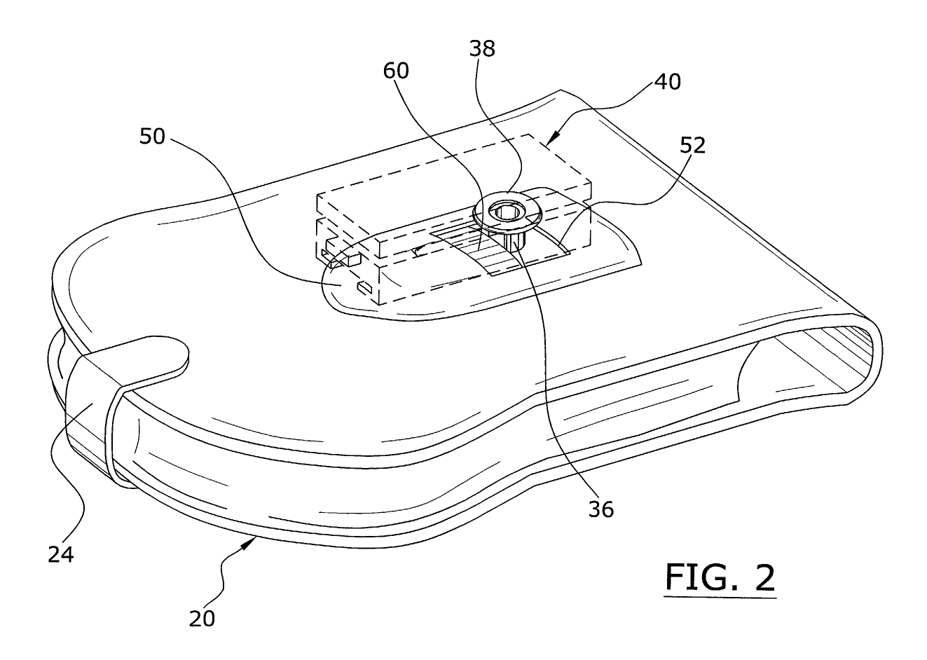

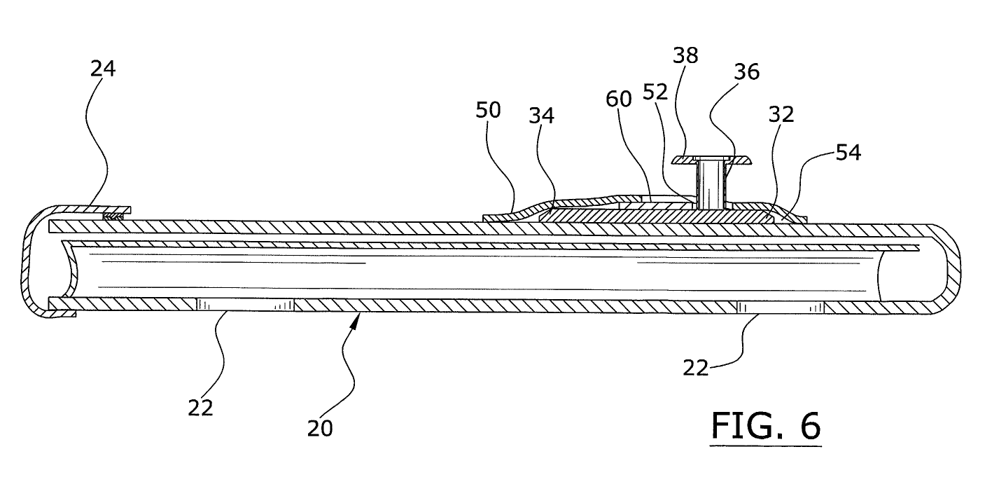

Turning now descriptively to the drawings, in which similar reference characters denote similar elements throughout the several views, FIGS. 1 through 11 illustrate a removable belt clip system 10, which comprises a carrying case 20, a retaining pocket 50 attached to an exterior surface of the case 20, a receiver opening 52 within the retaining pocket 50, a resilient member 60 attached at one end of the receiver opening 52 extending a finite distance toward the opposing end of the receiver opening 52, and a post member 30 having a flat base removably positioned within the receiver opening 52. The user inserts a second portion 34 of the flat base into the receiver opening 52 then pushes the post member 30 so that the shaft 36 engages and compresses the resilient member 60. The user then pushes the first portion 32 of the flat base into the receiver opening 52 and then releases the post member 30 whereby the resilient member 60 forces the flat base away from the resilient member 60 thereby causing the first portion 32 to be catchably received within the retaining pocket 50.

As shown in FIGS. 1 through 9 of the drawings, the carrying case 20 is comprised of a pocket structure for receiving an electronic device such as a cellular phone, PDA or similar device. The carrying case 20 may have one or more openings 22 within the front portion thereof to allow for viewing of a display within the electronic device. The carrying case 20 may also have a securing strap 24 or similar structure commonly utilized to retain the electronic device within the carrying case 20. The carrying case 20 may be comprised of various other structures and designs not illustrated within FIGS. 1 through 9 of the drawings. The structure of the carrying case 20 by itself is not crucial for the operation of the present invention.

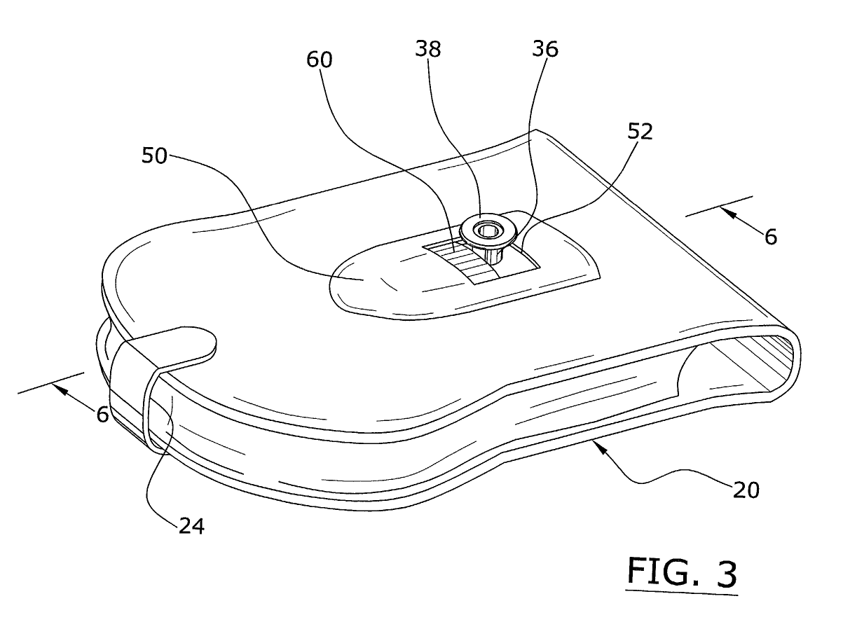

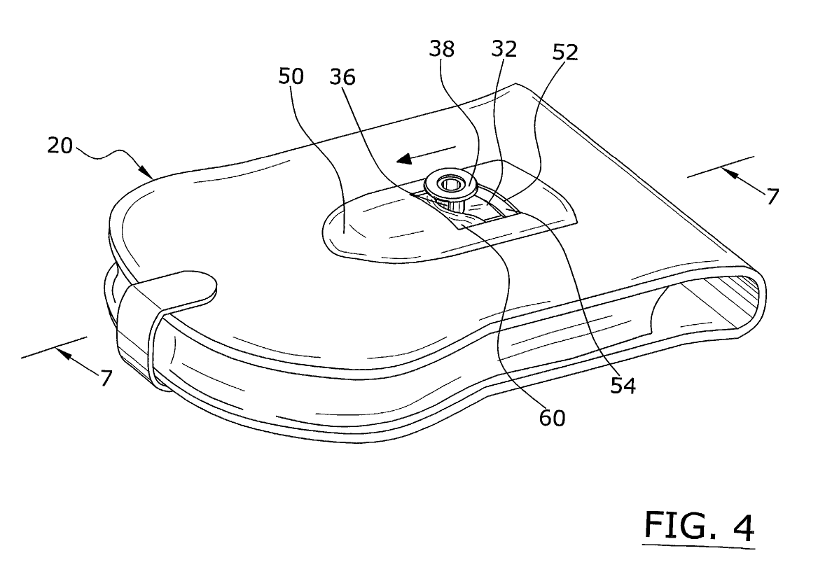

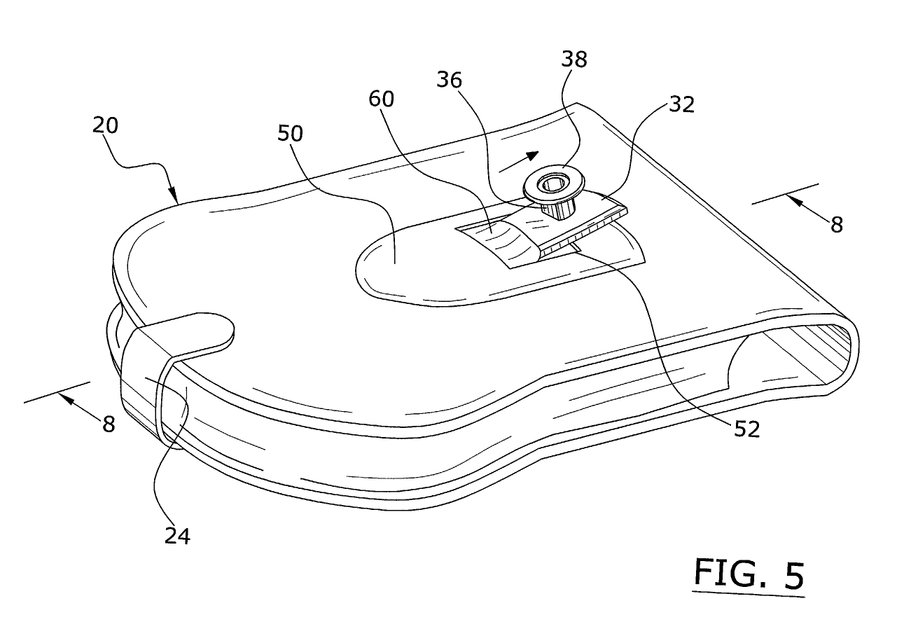

As shown in FIGS. 3 through 9 of the drawings, a retaining pocket 50 is attached to an exterior surface of the carrying case 20 thereby forming an interior cavity 54 between thereof. It can be appreciated that the retaining pocket 50 may be formed directly within the carrying case 20 without utilizing additional materials. The retaining pocket 50 has a receiver opening 52 that may have various shapes and sizes. The receiver opening 52 is formed for receiving the flat base of the post member 30 as shown in FIG. 5 of the drawings. The interior cavity 54 is also formed for receiving the entire flat base of the post member 30 as shown in FIGS. 3 and 4 of the drawings.

As shown in FIGS. 3 through 9 of the drawings, a resilient member 60 is attached to the retaining pocket 50 about a portion of the receiver opening 52. The resilient member 60 is preferably comprised of an elastic material, however, various other types of resilient materials may be utilized to construct the resilient member 60. The resilient member 60 is preferably attached within the interior cavity 54 of the retaining pocket 50, however, the resilient member 60 may be attached to the exterior surface of the resilient member 60 though not illustrated.

The resilient member 60 is preferably attached to a lower portion of the receiver opening 52 opposite of an upper portion of the receiver opening 52 for preventing accidental compression of the resilient member 60 when the post member 30 is attached to a belt clip structure 40. The resilient member 60 extends a finite distance toward the upper portion of the receiver opening 52 leaving a sufficient space for insertion of a portion of the flat base of the post member 30.

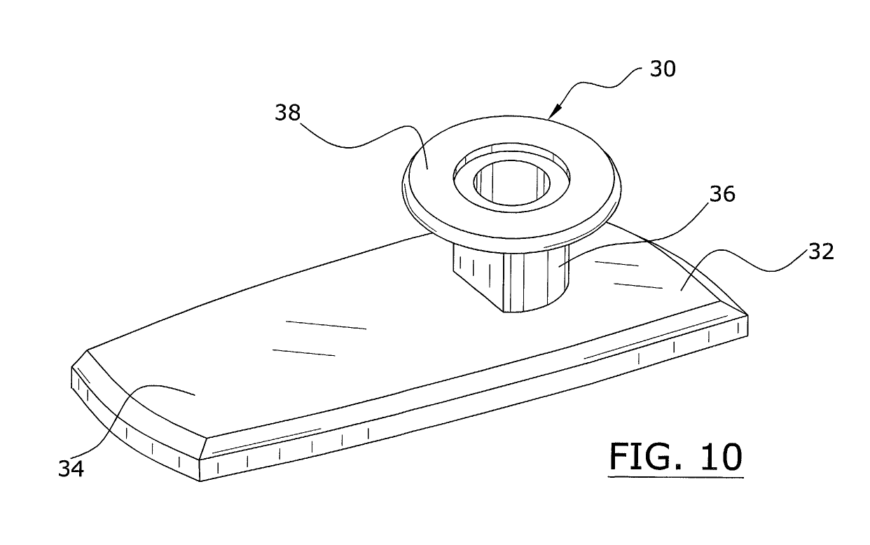

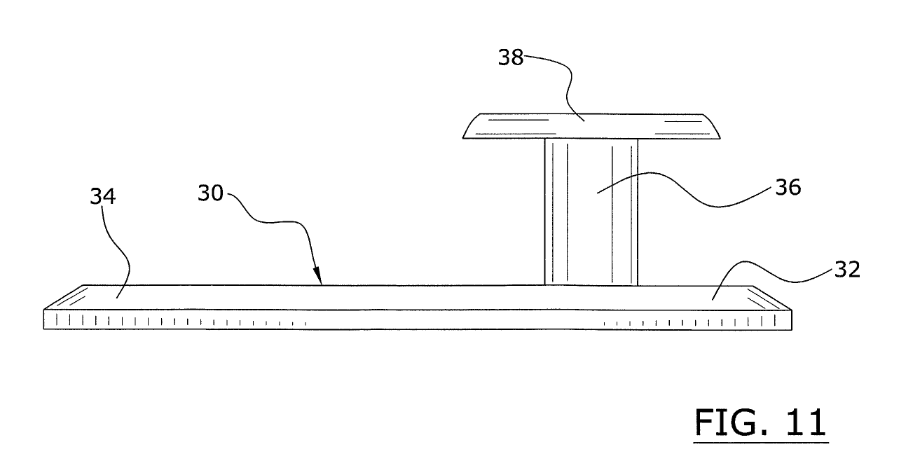

As shown in FIGS. 10 and 11 of the drawings, the post member 30 is comprised of a flat base having a first portion 32 and a second portion 34, a shaft 36 extending transversely from the flat base, and a flanged end 38 attached to the distal portion of the shaft 36. It can be appreciated that the shaft 36 and flanged end 38 may have various other structures not illustrated so as to be removably attachable within a belt clip structure 40. FIG. 1 illustrates an exemplary belt clip structure 40 having a receiving slot 42 for receiving the post member 30, a clip member 46 for attaching to a belt, and a locking member 44 manipulated by a control button 48 for allowing selective locking and release of the post member 30 within the receiving slot 42. It can be appreciated that the present invention may be utilized in conjunction with various other types of clip structures 40 not shown in the attached drawings.

The first portion 32 and the second portion 34 are defined as the two portions divided by the shaft 36 as shown in FIG. 11 of the drawings. As best shown in FIG. 11 of the drawings, the first portion 32 has a shorter length than the second portion 34. The second portion 34 of the flat base is the portion first inserted into the receiver opening 52. As best shown in FIG. 10 of the drawings, the flat base preferably has tapered upper edges to facilitate easy removal and insertion thereof into the retaining pocket 50.

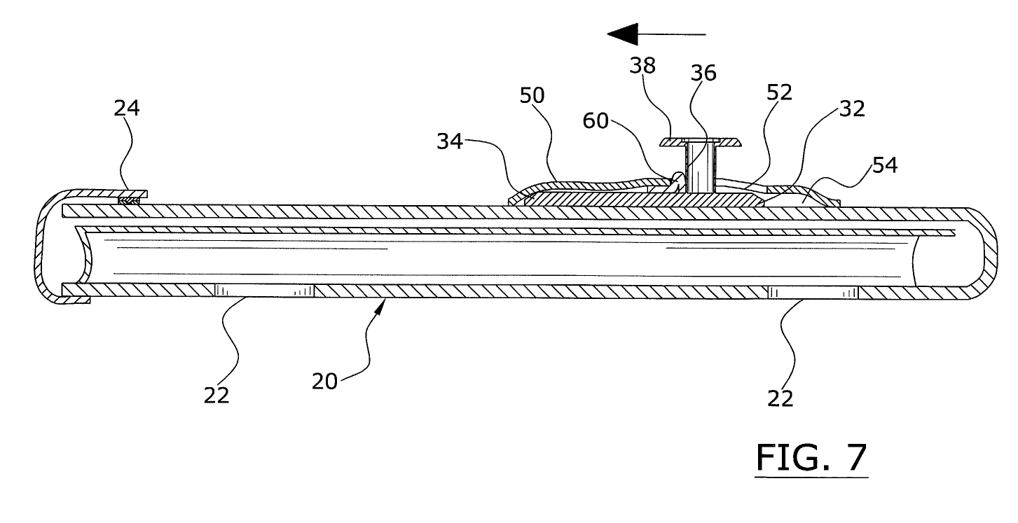

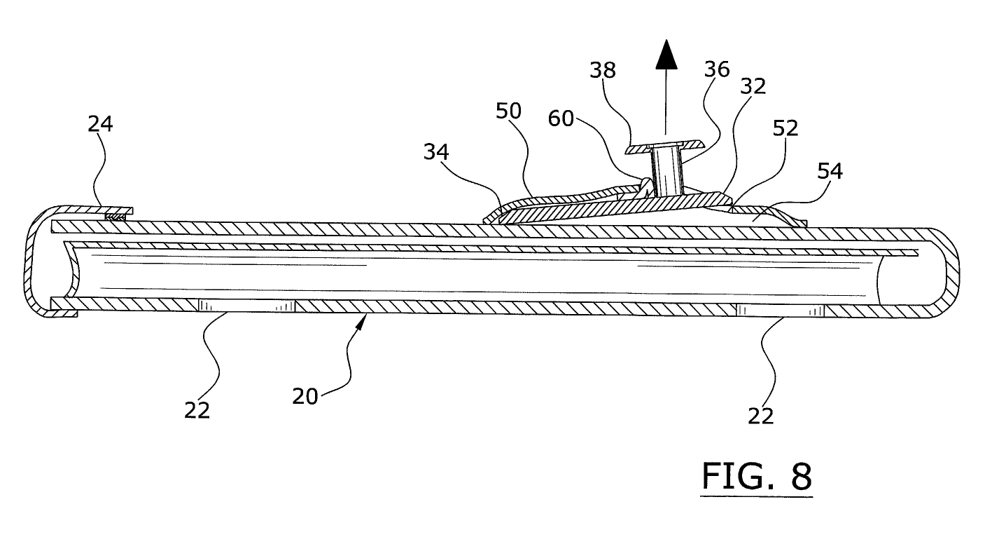

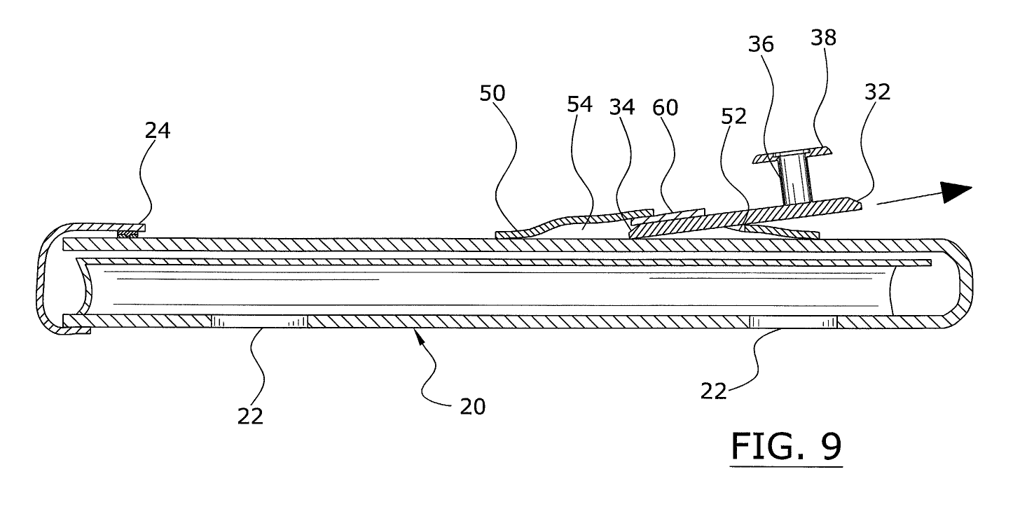

In use, the user inserts the second portion 34 of the flat base into the receiver opening 52 then pushes the post member 30 so that the shaft 36 engages and compresses the resilient member 60. The user then pushes the first portion 32 of the flat base downwardly into the receiver opening 52 and then releases the post member 30 whereby the resilient member 60 forces the flat base away from the resilient member 60 thereby causing the first portion 32 to be catchably received within the retaining pocket 50. The user may have to manipulate the post member 30 away from the resilient member 60 in the event the force of the resilient member 60 is insufficient for properly positioning the flat base within the retaining pocket 50. The user then may attached the post member 30 to a belt clip structure 40 or similar structure. When the user removes the carrying case 20 from the belt clip structure 40 and desires to utilize the electronic device without interference from the post member 30, the user first forces the post member 30 toward the resilient member 60 thereby compressing the resilient member 60 as shown in FIGS. 4 and 7 of the drawings. When either the resilient member 60 is fully compresses or the edge of the first portion 32 may pass through the receiver opening 52, the user then lifts the post member 30 to cause the first portion 32 to extend outwardly from within the receiver opening 52 as shown in FIGS. 5 and 8 of the drawings. As shown in FIG. 9 of the drawings, the user then pulls the post member 30 outwardly from the receiver opening 52 until completely removed from the retaining pocket 50. The user is then able to utilize the electronic device free of obstruction by the post member 30.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A removable belt clip system, comprising:
a carrying case for receiving a device;
a retaining pocket positioned within said carrying case;
a receiver opening within said retaining pocket;
a resilient member attached to said retaining pocket traversing a lower portion of said receiver opening; and
a post member having a flat base, a shaft extending from said flat base and a flanged end extending from a distal end of said shaft, wherein said flat base is removably positionable within said retaining pocket.

2. The removable belt clip system of claim 1, wherein said flat base has a first portion and a second portion divided by said shaft.

3. The removable belt clip system of claim 2, wherein said first portion is shorter than said second portion, and wherein said first portion is aligned with an upper portion of said retaining pocket.

4. The removable belt clip system of claim 1, wherein said resilient member is comprised of an elastic material.

5. The removable belt clip system of claim 1, wherein said resilient member is attached within an interior surface of said receiver cavity.

6. The removable belt clip system of claim 1, wherein said resilient member is attached within an exterior surface of said receiver cavity.

7. The removable belt clip system of claim 1, wherein said flat base of said post member has tapered edges.

8. The removable belt clip system of claim 1, wherein said receiver opening is comprised of a rectangular shape.

9. The removable belt clip system of claim 1, wherein said retaining pocket is positioned within a rear portion of said carrying case.

10. The removable belt clip system of claim 1, wherein said flat base has an elongate rectangular shape.

11. A removable belt clip system, comprising:
a carrying case for receiving a device;
a retaining pocket attached to a rear surface of said carrying case defining an interior cavity between thereof;
a receiver opening within said retaining pocket;
a resilient member attached to said retaining pocket traversing a lower portion of said receiver opening; and
a post member having a flat base, a shaft extending from said flat base and a flanged end extending from a distal end of said shaft, wherein said flat base is removably positionable within said retaining pocket.

12. The removable belt clip system of claim 11, wherein said flat base has a first portion and a second portion divided by said shaft.

13. The removable belt clip system of claim 12, wherein said first portion is shorter than said second portion, and wherein said first portion is aligned with an upper portion of said retaining pocket.

14. The removable belt clip system of claim 11, wherein said resilient member is comprised of an elastic material.

15. The removable belt clip system of claim 11, wherein said resilient member is attached within an interior surface of said receiver cavity.

16. The removable belt clip system of claim 11, wherein said resilient member is attached within an exterior surface of said receiver cavity.

17. The removable belt clip system of claim 11, wherein said flat base of said post member has tapered edges.

18. The removable belt clip system of claim 11, wherein said receiver opening is comprised of a rectangular shape.

19. The removable belt clip system of claim 11, wherein said flat base has an elongate rectangular shape.

20. A method of operating a removable belt clip system comprised of a carrying case for receiving a device, a retaining pocket attached to a rear surface of said carrying case defining an interior cavity between thereof, a receiver opening within said retaining pocket, a resilient member attached to said retaining pocket traversing a lower portion of said receiver opening, and a post member having a flat base, a shaft extending from said flat base and a flanged end extending from a distal end of said shaft, wherein said flat base is removably positionable within said retaining pocket, said method comprising the steps of:
(a) inserting a second portion of said flat base into said receiver opening;
(b) sliding said flat base toward said resilient member until said shaft engages said resilient member and compresses said resilient member so that an outer edge of a first portion of said flat base is passable within said receiver opening;
(c) positioning said first portion of said flat base within said receiver opening; and
(d) releasing said post member and thereby allowing said resilient member to push said post member away from said resilient member.
